(19) United States
(12) Patent Application Publication
(10) Pub. No.: US 2025/0146841 A1
(43) Pub. Date: May 8, 2025

(54) CAPACITIVE POSITION SENSING DEVICE

(71) Applicant: Grayhill, Inc., La Grange, IL (US)

(72) Inventors: Robert Kerner, Chicago, IL (US); Mateusz Pattermann, Chicago, IL (US); Andrew Wood Polk, IV, Indianapolis, IN (US); Adrian Martinez, La Grange, IL (US)

(21) Appl. No.: 18/938,660

(22) Filed: Nov. 6, 2024

Related U.S. Application Data
(60) Provisional application No. 63/596,696, filed on Nov. 7, 2023.

(51) Int. Cl. G01D 5/24

(52) U.S. Cl. CPC G01D 5/2403

(57) ABSTRACT

A capacitive sensing device is provided with a plurality of pads disposed on a base around a center of the base; a ground plane positioned above the plurality of pads; a rotor, positioned between the ground plane and the plurality of pads, configured to at least partially rotate about the center resulting in a portion of the rotor being positioned over different portions of the plurality of pads at different angles of rotation; and sensing circuitry connected to the plurality of pads in order to determine a position of the rotor; and wherein at least two pads of the plurality of pads are disposed in a shared arc defined from the center.

### PRIORITY CLAIM AND CROSS-REFERENCE TO RELATED DISCLOSURE

The present disclosure claims the benefit of and priority to U.S. Provisional Patent Application No. 63/596,696 titled “CAPACITIVE POSITION SENSING DEVICE” and filed on Nov. 7, 2023, which is incorporated herein it its entirety

### BACKGROUND

Many sensing methods have been utilized in user interfaces, which allow for direct control of a system, such as encoders having a user interface. These sensing methods include methods based on using mechanical contacts, optical sensors, piezo sensors, Hall effect sensors, inductive sensors, and capacitive sensors, arranged as switches, buttons, knobs, slides, touch pads, keypads, keyboards, and mice.

Specifically, past uses of capacitive sensing have been focused on sensing rotary or linear position. Capacitance is used to determine position in sensors directed at varying either the area of a parallel plate of the capacitor or the distance between parallel plates of a capacitor. Capacitive sensors generally offer a low power consumption, which can be critical in operating some devices, for example battery-powered devices. Accordingly, improved ways of capacitive sensing that improve the power consumption and other performance metrics of a sensor device are desired.

### SUMMARY

The present disclosure provides a device, comprising: a plurality of pads disposed around a center of a base disposed in a first plane; a ground plane, positioned in a second plane above the base; a rotor, disposed in a third plane between the first plane and the second plane and configured to rotate about the center; a sensing circuit, electrically connected to each pad of the plurality of pads and the ground plane, and configured to determine a rotational position of the rotor relative to the base based on a change in capacitance when the rotor is positioned between a given pad of the plurality of pads and the ground plane versus when the rotor is not positioned between the given pad and the ground plane; and wherein the given pad of the plurality of pads is divided into a first pad section and a second pad section that is coaxially separated from the first pad to both occupy a given arc at different distances from a reference point of the center.

In some embodiments, the first pad section has a first inner radius and the second pad section has a second outer radius, wherein a second pad of the plurality of pads occupies a second arc outside of the first arc at a distance between the first inner radius and the second outer radius.

In some embodiments, a combined area of the first pad section and the second pad section is substantially equal to an area of the second pad.

In some embodiments, first straight edges of each of the first pad section, the second pad section, and the second pad are co-linear to one another along a first alignment axis.

In some embodiments, second straight edges of each of the first pad section, the second pad section, and the second pad are co-linear to one another along a second alignment axis perpendicular to the first alignment axis.

In some embodiments, the rotor is shaped to be one of a: a semi-circle; a limaçon; a gear-shape, defining a plurality of paddles extending from a central body for a predefined distance at a regular interval about the central body.

In some embodiments, the sensing circuit is configured to determine the rotational position of the rotor via detecting a differential capacitance between pads of the plurality of pads that are positioned on opposite sides of the center.

In some embodiments, the rotor is composed of a material have a relative permittivity at least four times greater than the relative permittivity of free space.

In some embodiments, the rotor is shaped and sized such that, at any given time, the rotor is positioned completely over exactly one pad of the plurality of pads and is positioned such that rotor is not at all positioned over exactly one pad of the plurality of pads.

The present disclosure provides a device, comprising: a plurality of six pads disposed around a center of a base disposed in a first plane; a ground plane, positioned in a second plane above the base; a rotor, disposed in a third plane between the first plane and the second plane and configured to rotate about the center; a sensing circuit, electrically connected to each pad of the plurality of pads and the ground plane, and configured to determine a rotational position of the rotor relative to the base based on a change in capacitance when the rotor is positioned between a given pad of the plurality of pads and the ground plane versus when the rotor is not positioned between the given pad and the ground plane; and wherein the plurality of six pads are disposed concentrically to one another, each defining a 360 degree arc around the center.

In some embodiments, a first pair of the six pads are connected to the sensing circuit via a first trace as a first capacitance sensor, a second pair of the six pads are connect to the sensing circuit as a second capacitance sensor, and a third pair of the six pads are connected to the sensing circuit as a third capacitance sensor, wherein the third sensor is disposed between the second pair of the six pads and the second sensor is disposed between the first pair of the six pads.

In some embodiments, the first sensor is a first one of: a reference sensor; a sine sensor; and a cosine sensor; the second sensor is a second one of: the reference sensor; the sine sensor; and the cosine sensor; and the third sensor is a third one of: the reference sensor; the sine sensor; and the cosine sensor.

In some embodiments, the rotor is positioned off-center relative to the center, wherein a reference capacitance measured from the reference sensor is subtracted from a sine capacitance measured from the sine sensor and subtracted from a cosine capacitance measured from the cosine sensor to calculate an angle of rotation of the rotor that compensates for the rotor being positioned off-center relative to the center.

In some embodiments, for each given pad of the plurality of six pads, a given difference between a given outer radius of a given pad and an inner radius of the given pad is substantially equal to a second difference between a second outer radius and a second inner radius for every other pad of the plurality of six pads.

In some embodiments, the rotor is shaped to be one of a: a semi-circle; a limaçon; a gear-shape, defining a plurality of paddles extending from a central body for a predefined distance at a regular interval about the central body.

The present disclosure provides a device, comprising: a base having a printed circuit board; a plurality of pads disposed on the base around a center of the base; a ground plane positioned above the plurality of pads; a rotor, positioned between the ground plane and the plurality of pads, configured to at least partially rotate about the center resulting in a portion of the rotor being positioned over different portions of the plurality of pads at different angles of rotation; and sensing circuitry disposed on the printed circuit board and connected to the plurality of pads in order to determine a position of the rotor; wherein at least two pads of the plurality of pads are disposed in a shared arc defined from the center.

In some embodiments, each pad of the plurality of pads is disposed concentrically to one another, wherein the shared arc defines a 360 degree arc around the center.

In some embodiments, for each given pad of the plurality of pads, a given difference between a given outer radius of a given pad and an inner radius of the given pad is substantially equal to a second difference between a second outer radius and a second inner radius for every other pad of the plurality of six pads.

In some embodiments, the at least two pads of the plurality of pads that are disposed in the shared arc act as a single pad that is divided into a first pad section and a second pad section that is coaxially separated from the first pad to both occupy the shared arc at different distances from a reference point of the center.

In some embodiments, the first pad section and the second pad section define a combined surface area that is substantially equal to an individual surface area of every other pad of the plurality of pads.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIGS. 1A-1C illustrates an example device of the present disclosure showing an example base, plurality of pads, and rotor.

FIGS. 2A-2C illustrate additional geometries for example elements of an example device of the present disclosure.

FIG. 3 illustrate additional geometries for example elements of an example device of the present disclosure.

FIGS. 4A-4C illustrate additional geometries for example elements of an example device of the present disclosure.

FIGS. 5A-5B illustrate additional geometries for example elements of an example device of the present disclosure.

FIGS. 6A-6F illustrate additional geometries for example elements of an example device of the present disclosure.

FIG. 7 illustrate an example computing device as may be used with the device of the present disclosure to calculate a rotational or absolute position of a rotor relative to a center of a plurality of pads.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

A capacitive position sensing device is provided.

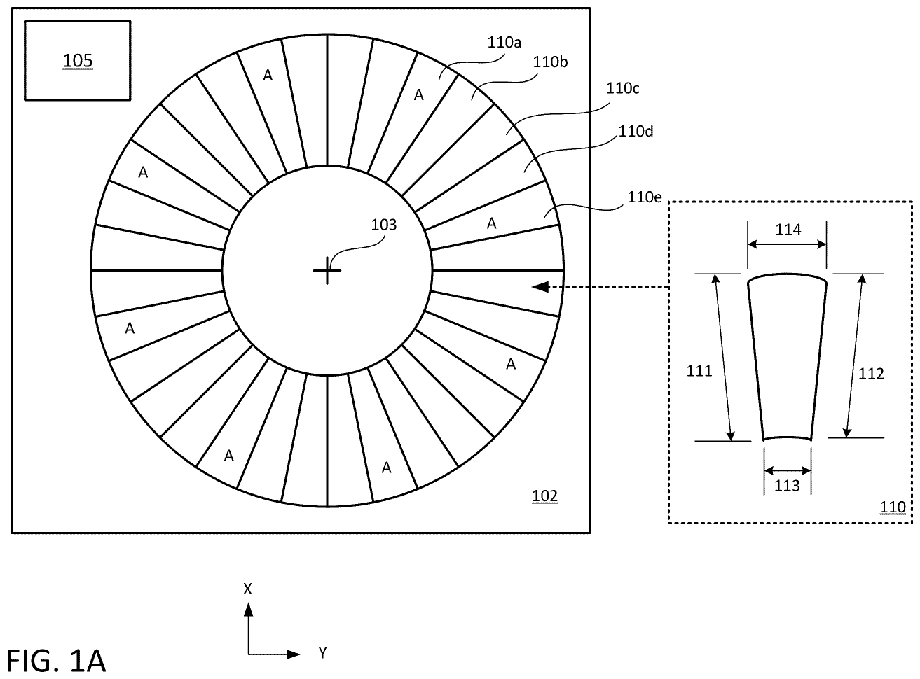

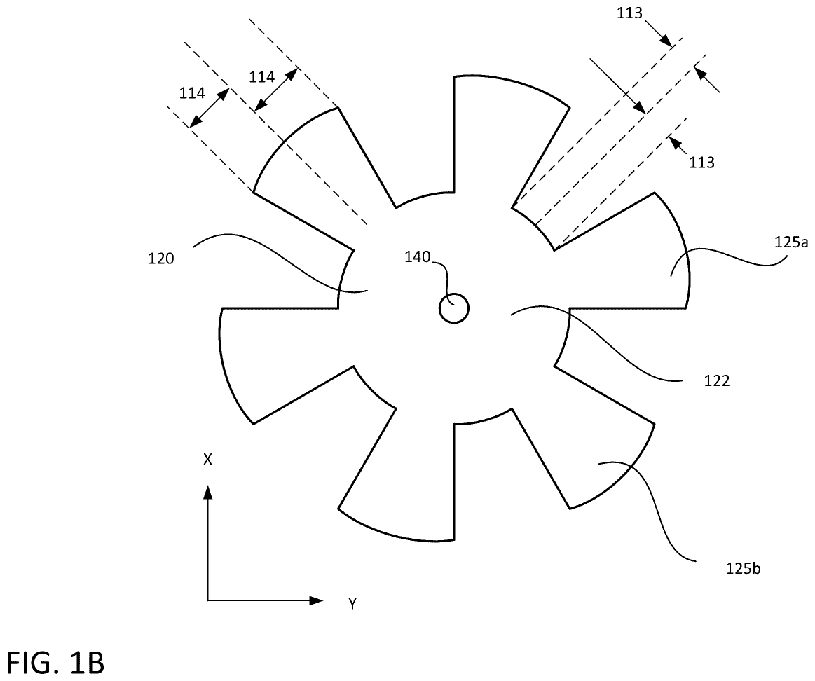

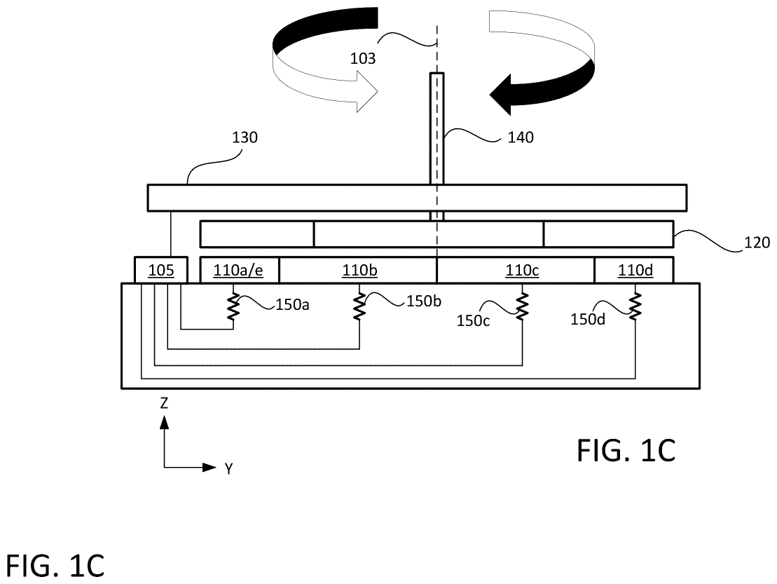

FIGS. 1A-1C illustrate an example device 100 of the present disclosure. As shown in FIG. 1A, the device 100 includes a base 102, having a printed circuit board disposed thereon. The device 100 also includes a plurality of pads 110a-e (generally or collectively, pads 110) disposed on the printed circuit board of the base 102 around a center 103 of the base 102. Each pad 110 has a first pad length 111, a second pad length 112, a first pad width 113, and a second pad width 114. In an example of the present disclosure, the plurality of pads 110 may be disposed in a circular pattern around the center 103 of the base 102. Each pad 110 may be a sensor configured to measure capacitance.

As shown in FIGS. 1B-1C, the device 100 includes a rotor 120 positioned at the center 103 of the base 102 and configured to at least partially rotate about the center 103 (e.g., no more than N degrees from a home position, or any number of degrees from a home position including more than 360 degrees) in response to a first input from a user on an axle 140 connected to the rotor 120 resulting in a portion of the rotor 120 being positioned over a predetermined quantity of the plurality of pads 110. The device 100 includes a ground plane 130 positioned above the rotor 120 and the plurality of pads 110, such that the rotor 120 may be rotated between the ground plane 130 and the plurality of pads 110 disposed on the base 102. Although illustrated as passing through the ground plane 130, the present disclosure contemplates that the axle 140 may additionally or alternatively pass through the base 102, or that the axle 140 may be disposed radially outward to the rotor 120 (and one or both of the base 102 and ground plane 130) impart rotational force on a circumferential edge of the rotor 120.

The device 100 includes or is in communication with sensing circuitry 105 disposed on the printed circuit board on the base 102. The sensing circuitry 105 may be connected to the plurality of pads 110 and the ground plane 130 in order to determine a rotational position of the rotor 120 in response to rotational input.

The plurality of pads 110 may be organized in a repeating pattern based the connection of each pad 110 with the sensing circuitry 105. For example, the pads 110 may be organized in a pattern of pad 110a, 110b, 110c, 110d, 110e, etc., in which series of pads 110 are connected to the sensing circuitry 105 via a shared connection In other words, the pattern repeats around the circle; those pads 110 all connected as pads 110a/110c have been labeled with an ‘A’ for illustrative purposes in FIG. 1A. For discussion purposes, these will be referred as the A series of pads, with the other pads belonging to one of the B series, C series, or D series, respectively.

Although illustrated as being in circumferential contact with one another around the center 103 (e.g., a first side of pad 110b touches a second side of pad 110a and a second side of pad 110b touches a first side of pad 110c), the present disclosure contemplates that the pads 110 may be spaced apart from one another by the use of non-conductive or semi-conductive materials used as spacers (e.g., the material of the circuit board of the base 102).

As shown in FIG. 1B, the rotor 120 may be configured to be generally gear-shaped and have a plurality of paddles 125a-b (generally or collectively, paddle 125) each having a first paddle length, a second paddle length, a first paddle width, and a second paddle width. When configured to be gear-shaped, the rotor 120 defines a plurality of paddles 125 that extend from a central body 122, each for a predefined distance, at a regular interval about the central body 122. In an example of the present disclosure, in which the plurality of pads 110 is disposed in a circular pattern around the center 103 of the base 102, the values of the dimensions of each paddle 125 relative to the values of the dimensions of each pad 110 may be such that each paddle 125 is be fully positioned to cover two pads 110 at a time. Each paddle 125 may be positioned on the rotor 120 such that the paddle 125 is spaced from the next closest paddle 125 (e.g. paddle 125a versus paddle 125b), by a space equal to the first pad widths 113 and second pad widths 114 of two pads 110. In other words, each paddle 125 may be spaced apart from the adjacent paddle 125 by a space equal to that of two of the pads 110 of the plurality of pads 110 disposed on the printed circuit board of the base 102.

In various embodiments, the rotor 120 is formed from plastic, or another material having a relative permittivity higher than that of free space (air). For example, the rotor 120 may be composed of a plastic material having a relative permittivity four times greater than the relative permittivity of free space. The greater the relative permittivity of the rotor 120 compared to that of air, the more a device 100 of the present disclosure is able to withstand the effects of parasitic capacitance and noise that may arise during operation.

Although illustrated in FIG. 1C as a partially exploded view (e.g., with a gap between the rotor 120 and the pads 110 and a gap between the rotor 120 and the ground plane 130 for ease of visualizing the components), the present disclosure contemplates that the rotor 120 may be in physical contact with the pads 110 and the ground plane 130 so that capacitive communication is increased/established between the pads 110 and the ground plane 130, with portions of the rotor 120 (e.g., the paddles 125) via the present of the portions of the rotor 120 between corresponding pads 110 and the ground plane 130.

In one example, the plurality of pads 110 are disposed in a circular pattern around the center 103 of the base 102, as shown in FIG. 1A, with a rotor 120, as depicted in FIG. 1B, with each paddle 125 fully covering two pads 110, positioned above base 102. The pads 110 of are connected to the sensing circuitry 105 in the repeating pattern shown in FIG. 1A: pad 110a, pad 110b, pad 110c, pad 110c, and pad 110e. The sensing circuitry 105 includes a low power oscillator connected to four resistors 150a-d (generally or collectively, resistors 150) on the printed circuit board of the base 102. Each series of pads 110 is coupled to one of the resistors 150 to define the different series A-D of pads 110, and the resistors 150 may have the same nominal resistance as one another or may be specified with different resistances. Whenever a paddle 125 of the rotor 120 is positioned over a pad 110, the capacitance between that pad 110 and the ground plane 130 is greater than the capacitance would be without the rotor 120 in between, because the permittivity of the rotor 120 is significantly greater than that of free space. As a result of this increased capacitance, the charge time is increased (i.e., is slower) through the associated resistor 150, resulting in a delay in the rise of the oscillator signal. Accordingly, a relative position may be determined based on the dimensions of the paddles 125 and the connection scheme of the pads 110 and resistors 150.

For example, because pad 110a and pad 110c are separated by pad 110b, using the rotor 120 shown in FIG. 1B, the A series pads 110 have a higher capacitance than the C series pads 110 for two of the positions of the rotor 120, and the C series pads 110 have a higher capacitance than the A series pads 110 for two of the positions of the rotor 120. In various embodiments, the sensing circuitry 105 is connected to the pads 110 such that when a charge time through the resistor 150a connected to A series pads 110 is slower (e.g., due to increased capacitance as a result of the rotor 120 separating the pad 110a from the ground plane 130) than the charge time through the resistor 150c connected to the C series pads 110 (due to there being lower capacitance, as the rotor 120 is not blocking the space between the pad 110c and the ground plane 130) then the circuit of the sensing circuitry 105 connected to these series of pads 110 outputs a binary one (e.g., TRUE or [0001]). Conversely, when the C series pads 110 display a slower charge time than the A series pads 110, the circuit of the sensing circuitry 105 connected to these series of pads 110 outputs a binary zero (e.g., FALSE or [0000]). As the rotor 120 is rotated over the plurality of pads 110, this circuit of the sensing circuitry 105 connected to the A series and C series pads outputs a square wave, being high for two positions of the rotor 120 and low for two positions of the rotor 120. Additionally, the connections between the pads 110 and the sensing circuitry 105 may include conductive feed lines that are arranged to reduce effects of parasitic capacitance.

In this example, the sensing circuitry 105 includes a similar circuit connected to the B series pads 110 and D series pads 110 to that described with respect to the A series and C series pads 110, such that, as the rotor 120 is rotated over the plurality of pads 110, the circuit outputs a square wave out of phase with the output of the circuit connected to the A series pads and C series pads. The outputs of these two circuits form a quadrature signal that is detected by the sensing circuitry 105. Accordingly, based on the inputs received from the plurality of pads 110, the sensing circuitry 105 may determine the direction of rotation of the rotor 120 and number of positions the rotor 120 was rotated. Therefore, the relative position and change of position of the rotor 120 may be detected by the sensing circuitry 105, in response to at least partial rotation of the rotor 120 by a user. For example, the device 100 may be implemented as part of an encoding device deployed as a volume knob in a vehicle. Accordingly, in response to a user turning the volume knob, which may be coupled to the rotor 120, resulting in a partial rotation of the rotor 120, the sensing circuitry 105 may determine the direction of rotation (e.g., clockwise vs. counterclockwise) and relative change in position (e.g., N degrees), which may be translated to a reduction or increase in volume of audio of a device coupled to the volume knob. Detecting direction and position by determining a change in the capacitance in this way due to a modulation of the permittivity of the space between the plurality of pads 110 and the ground plane 130 caused by a rotation of the rotor 120 is able to be achieved at a very low power cost, compared to other capacitance sensing means or methods.

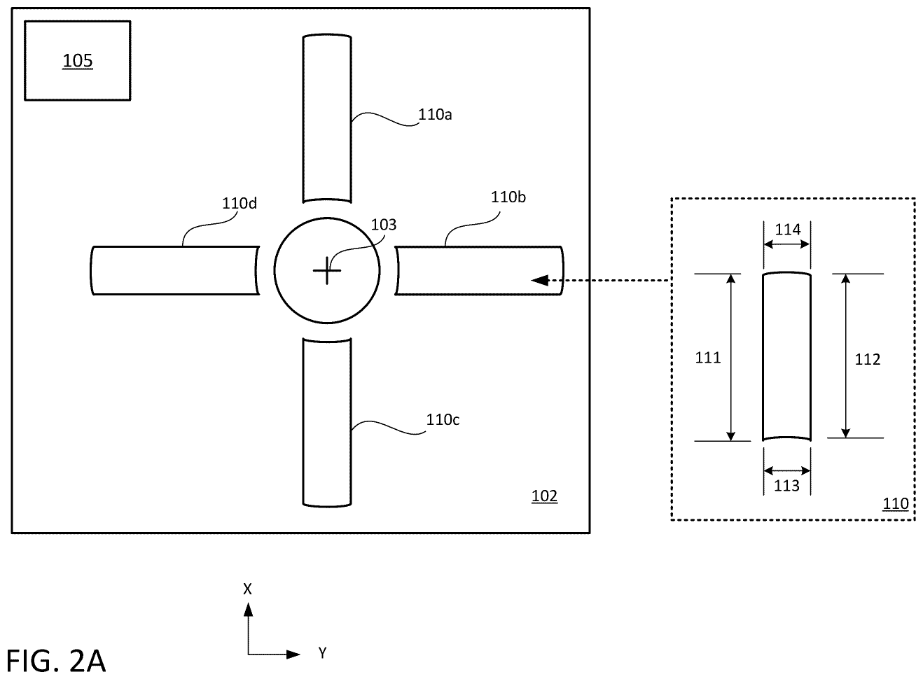

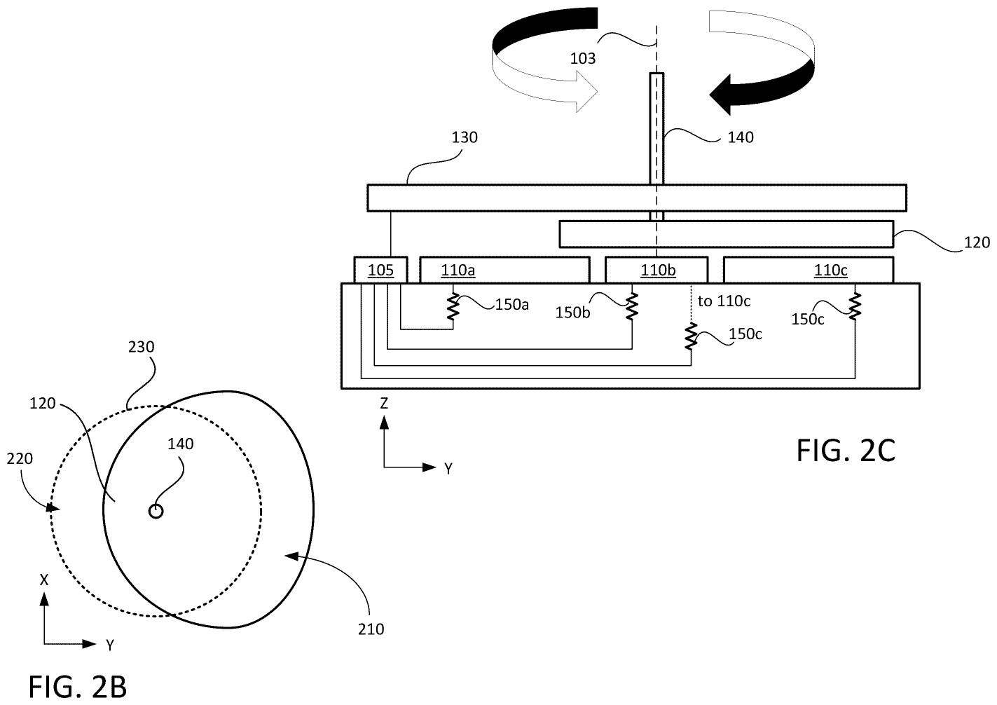

FIGS. 2A-2C illustrate an example device 100 of the present disclosure. As seen in FIG. 2A, the base includes a plurality of pads 110a-d disposed around the center 103 of the base 102 in the cardinal directions or in a cross shape. Pads 110a and 110b, located in the “north” and “south” positions respectively, are connected to a circuit of the sensing circuitry 105 configured to measure the differential capacitance of these oppositely positioned pads. Similarly, pads 110c and 110d are connected to a circuit of the sensing circuitry 105 configured to measure the differential capacitance of these oppositely positioned pads 110.

As seen in FIG. 2B, the rotor 120 is a modified limaçon shape, such that when the rotor 120 is rotated over the pads shown in FIG. 2A, the sensing circuitry 105 connected to pad 110a and pad 110c may output a sine wave. Additionally, as this rotor 120 or the sensing circuitry 105 connected to pad 110b and pad 110d may output a cosine wave. Accordingly, the angle of the rotor 120 may be determined by the sensing circuitry 105 by calculating the inverse tangent of the ratio of the detected differential capacitances.

A rotor 120 of a standard limaçon shape may be modified in order to compensate for error resulting from the shape of the individual pads 110, because the shape of the pads 110 affects the shape of the output signal. For example, the angle between the ends of the second pad width 114 of pad 110a and the center 103 of the base 102 is larger than the angle between the ends of the first pad width 113 of pad 110a and the center 103 of the base 102; however, the sine or cosine waves received at the sensing circuitry 105 as a result of the rotation of the rotor 120 are averaged over the thickness of the pad 110a using a fixed angle, even though the angles are different relative to the center 103 of the base 102. This averaging of a sine or cosine wave over a fixed angle still results in a sine wave, although the amplitude is reduced, with greater amounts of reduction as the angle is increased. Accordingly, the limaçon may be modified in shape to ensure that when the rotor 120 maximally covers pad 110a, that the angle will be at a minimum. Similarly, the shape of the limaçon modified to minimize the angle at maximal coverage can result in a maximal angle when coverage is at a minimum. Therefore, the shape of the rotor 120 and pads 110 may be modified to reduce computing complexities.

In various embodiments, the limaçon may be modified according to the following Formulas 1-3, when used with straight pads 110 (e.g., as in FIG. 1A), where M is the magnitude in polar coordinates, θ is the angle, Pw is the pad width, I, is the inner radius of the pad, and Or is the outer radius of the pad.

$${M}_{n} = sin ( θ ) * \frac{( {O}_{r} - {I}_{r} )}{2} + \frac{( {O}_{r} + {I}_{r} )}{2} \qquad Formula 1$$

$${A}_{o} = 2 * a sin ( 0.5 * \frac{{P}_{w}}{{M}_{n}} ) \qquad Formula 2$$

$$M = {M}_{n} - ( \frac{- cos ( θ + 0.5 * {A}_{o} ) + cos ( θ - 0.5 * {A}_{0} )}{{A}_{0}} - sin ( θ ) ) * \frac{( {O}_{r} - {I}_{r} )}{2} \qquad Formula 3$$

Similarly for wedge pads 110 (e.g., as in FIG. 2A), the magnitude may be determined according to Formula 4.

$$M = \sqrt{( {O}_{r}^{2} - {I}_{r}^{2} ) * \frac{sin ( θ ) + 1}{2} + {I}_{r}^{2}} \qquad Formula 5$$

Although illustrated in FIG. 2C as a partially exploded view (e.g., with a gap between the rotor 120 and the pads 110 and a gap between the rotor 120 and the ground plane 130 for ease of visualizing the components), the present disclosure contemplates that the rotor 120 may be in physical contact with the pads 110 and the ground plane 130 so that capacitive communication is increased/established between the pads 110 and the ground plane 130, with portions of the rotor 120 (e.g., extensions 210 of the limaçon that are out-of-circular vs the areas 220 that are not covered by the limaçon within a circle 230 of the same area and centered on the axle 140 of the limaçonular rotor 120) via the present of the portions of the rotor 120 between corresponding pads 110 and the ground plane 130.

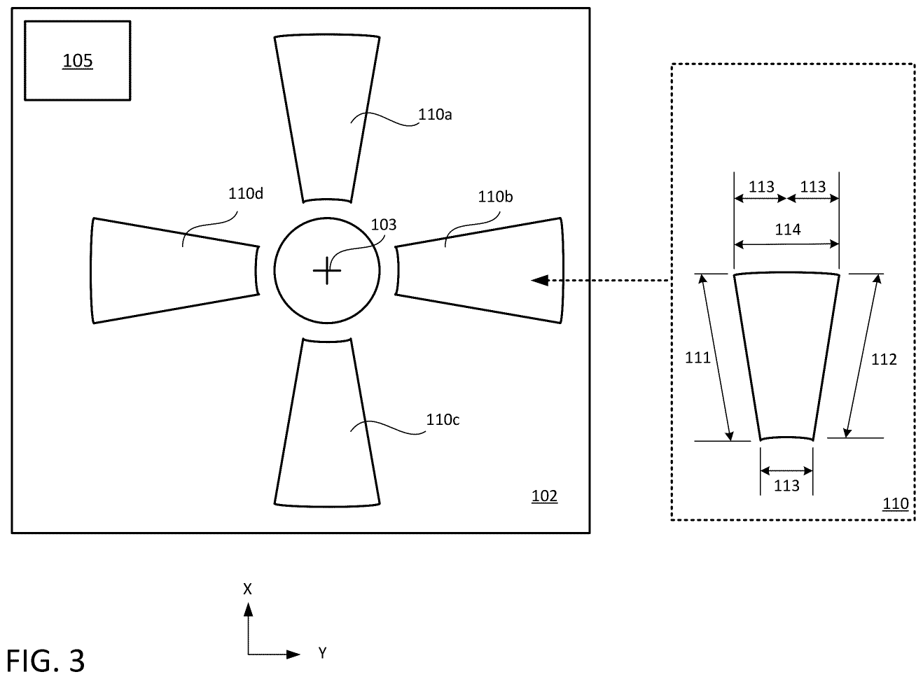

FIG. 3 illustrates an example device 100 of the present disclosure. As shown in FIG. 3, the plurality of pads 110 are disposed around the center 103 of the base 102 in a circular pattern, with each pad 110 being substantially wedge shaped, wherein the first pad width 113 is approximately half the size of the second pad width 114. In this arrangement, a modified limaçon shaped rotor 120, as is discussed with respect to FIGS. 2B-2C, is used to modulate the permittivity between the ground plane 130 and the plurality of pads 110.

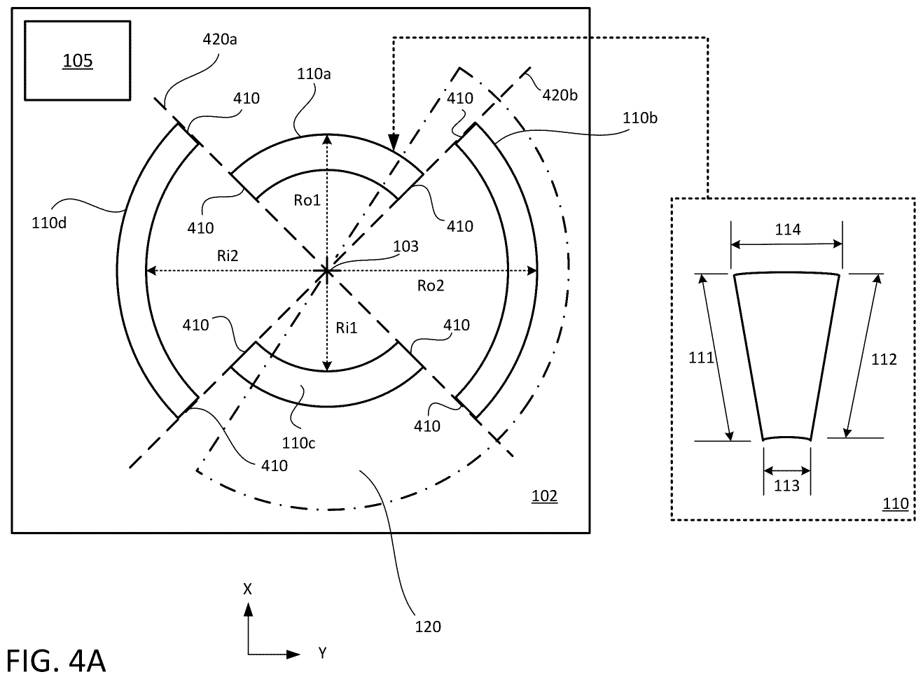

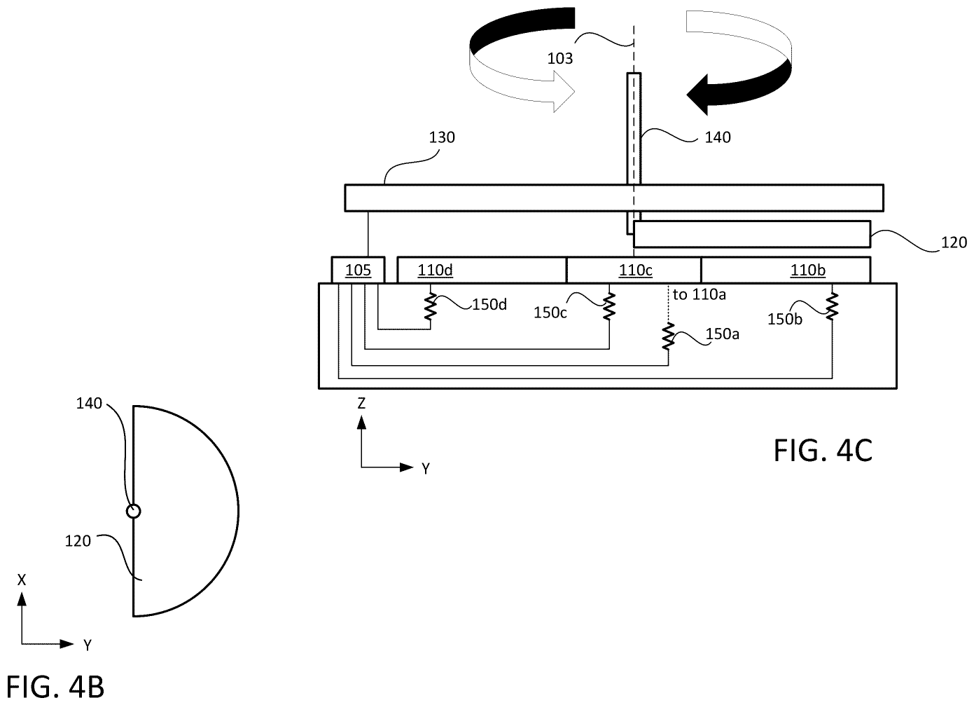

FIGS. 4A-4C illustrate an example device 100 of the present disclosure. As shown in FIG. 4A, the plurality of pads 110 includes four curved pads 110a-d (as truncated wedges), each having the same area, and arranged such that the straight edges 410 of each pad 110 are collinear with a straight edge 410 from each other pad 110. The first pad 110a and the third pad 110c have a first inner radius Ri1 and a first outer radius Ro1 while the second pad 110b and the fourth pad 110d have a second inner radius Ri2 and a second outer radius Ro2. The radii Ri1, Ri2, Ro1, Ro2 differ from one another such that the straight edges 410 of the pads 110 are colinearly aligned with each other (e.g., on alignment axes 420a-b) and to avoid the need for an isolation gap between otherwise adjacent pads 110. The straight edges 410 of the pads 110 are thereby aligned to the co-linear to other straight edges 410 along the alignment axes 420. Although illustrated with the straight edges 410 aligned on two perpendicular alignment axes 420, the present disclosure contemplates that for different numbers of pads 110 a greater number of alignment axes 420 may be defined such that the straight edges 410 of one pads 110 are aligned with the straight edges 410 of other (but not necessarily all) of the pads 110 of the plurality of pads 110.

In the illustrated example, the rotor 120 is shaped like a half circle and is positioned such that, at any given time, one pad 110 of the plurality remains uncovered by the rotor 120 (e.g., pad 110d in the illustrated example), one pad 110 of the plurality remains completely covered (e.g., pad 110b in the illustrated example), with the other pads 110 being partially covered (e.g., pads 110a, 110c in the illustrated example). Although illustrated with a semi-circular rotor 120 shaped to define a half circle (e.g., defining an arc of 180 degrees), the present disclosure contemplates that semi-circle shapes for the rotor 120 may define an arc between 120 degrees and 240 degrees to fully/partially/not cover the desired number of pads 110 according to the arrangement thereof on the base 102.

In various embodiments, Formula 5 may be used to determine the absolute position of the rotor 120 by comparing the capacitances of the different pads 110, where Pos=Encoder Absolute Position, Res=Encoder Resolution, Imax=an index number for the pad with the maximum capacitance, C (max+1)=the capacitance of the pad at one position above the maximum capacitance pad, C (max−1)=the capacitance of the pad at one position below the maximum capacitance pad, Cmax is the capacitance of the pad with maximum capacitance, and Cmin is the capacitance of the pad with minimum capacitance.

$$Pos = \frac{Res}{4} * ( I max + . 5 + \frac{C ( max + 1 ) - C ( max - 1 )}{2 ( C max - C min )} \qquad Formula 5$$

Although illustrated in FIG. 4C as a partially exploded view (e.g., with a gap between the rotor 120 and the pads 110 and a gap between the rotor 120 and the ground plane 130 for ease of visualizing the components), the present disclosure contemplates that the rotor 120 may be in physical contact with the pads 110 and the ground plane 130 so that capacitive communication is increased/established between the pads 110 and the ground plane 130, with portions of the rotor 120 via the present of the portions of the rotor 120 between corresponding pads 110 and the ground plane 130.

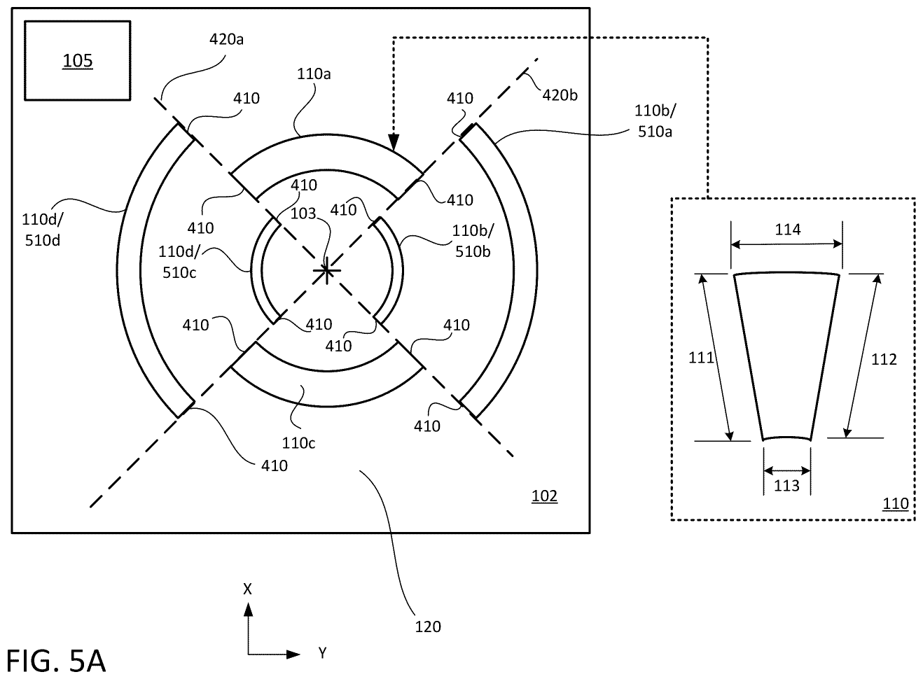

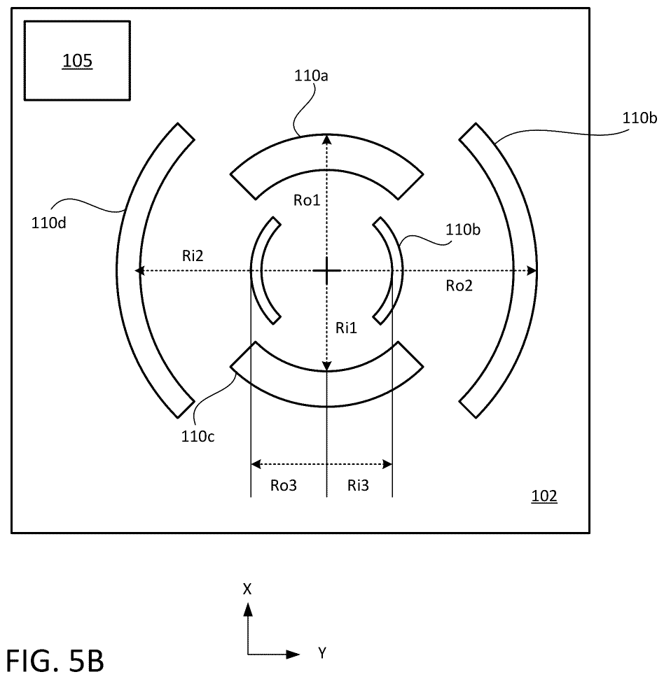

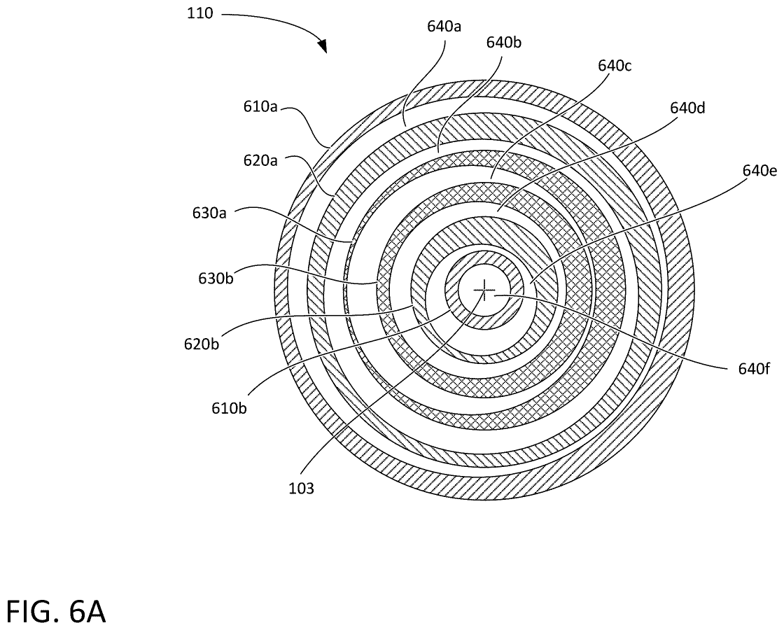

FIGS. 5A-5B illustrate an example device 100 of the present disclosure. As illustrated in FIGS. 5A-5B, the plurality of pads 110 may include four curved pads 110a-d, each having the same area, and arranged such that the straight edges 410 of each pad 110 are collinear with a straight edge 410 of the other pads 110 (e.g., on one of the alignment axes 420a-b). As error may result in the capacitance calculations and subsequent position determination if the rotor 120 is not positioned exactly at the center 103, which is also the center of the arrangement of the plurality of pads 110, some of the pads 110 may be split into multiple pad sections 510a-d (generally or collectively, pad sections 510) to reduce the error, while ensuring that cumulatively the pads 110 each have an equal area.

For example, a second pad 110b may be split into a first pad section 510a and second pad section 510b may have a cumulative area equal to the area of pad 110a (and pad 110c) and to the area of pad 110d. Likewise, a fourth pad 110d may be split into a third pad section 510c and a fourth pad section 510d, which have a cumulative area equal to the area of pad 110a (and pad 110c) and to the area of pad 110b. Each of the pad sections 510 of a given pad 110 are connected to the circuitry 105 via a shared resistor 150 and associated traces (e.g., pad section 510a and pad section 510b are connected as a single pad 110b via resistor 150b to the circuitry 105). Accordingly, the sensing circuitry 105 may determine the absolute position of the rotor 120 as described herein using pads 110 that are provided as distinct units (e.g., as shown in FIG. 4A) or divided into pad sections 510 (e.g., as shown in FIG. 5A). The example device 100 offers a method of calculating absolute position using capacitive at a lower cost than other known means or methods, such as using a Hall effect sensor.

FIG. 5B illustrates the device 100 as shown in FIG. 5A with various elements not labeled so as to more clearly illustrate the differing radii of curvature of the pads 110 and pad sections 510 thereof. The first pad 110a and the third pad 110c have a first inner radius Ri1 and a first outer radius Ro1. The second pad 110b and the fourth pad 110d are divided into pad section 510, which have separate inner and outer radii. The first pad section 510a and the fourth pad section 510d (the outer pad sections 510) have a second outer radius Ro2 and a second inner radius Ri2, while the second pad section 510b and the third pad section 510c (the inner pad sections 510) have a third outer radius Ro3 and a third inner radius Ri3. The radii Ri1, Ri2, Ri3, Ro1, Ro2, Ro3 differ from one another such that the straight edges 410 of the pads 110 are colinearly aligned with each other (e.g., on alignment axes 420a-b) and to avoid the need for an isolation gap between otherwise adjacent pads 110.

Although illustrated as being coaxially separated into two pad sections 510, the present disclosure contemplates that a pad 110 may be divided into any number of pad sections 510. As used herein, “coaxial separation”, being “coaxially separated”, and variations thereof refer to a spatial configuration in which two (or more) elements are defined at different radial distances from a reference point and occupy at least some of a shared arc defined along those radial distances. For example, each of the first pad section 510a and the second pad section 510a occupy an arc of 90 degrees relative to the center 103, but in an area defined between the second inner and outer radii (e.g., Ri2 to Ro2) and the third inner and outer radii (Ri3 to Ro3), respectively. To enable the areas of the pads 110 remain equal when split into coaxially separated pad sections 510, the outer radius (e.g., Ro3) of the inner pad sections 510 is less than the inner radius of the pad 110 (or pad section 510 defined) radially between (albeit outside of the shared arc). Stated differently, Ri1 is greater than Ro3 and Ri2 is greater than Ro1.

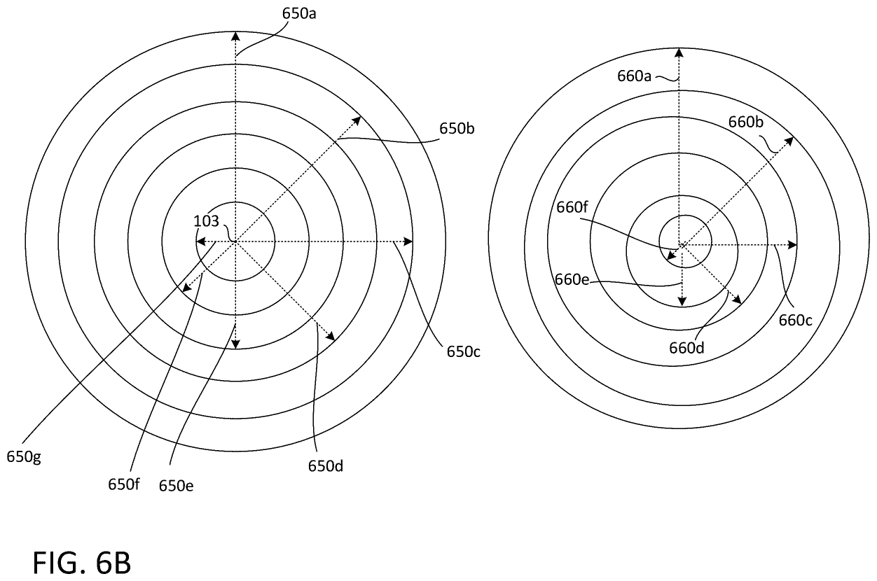

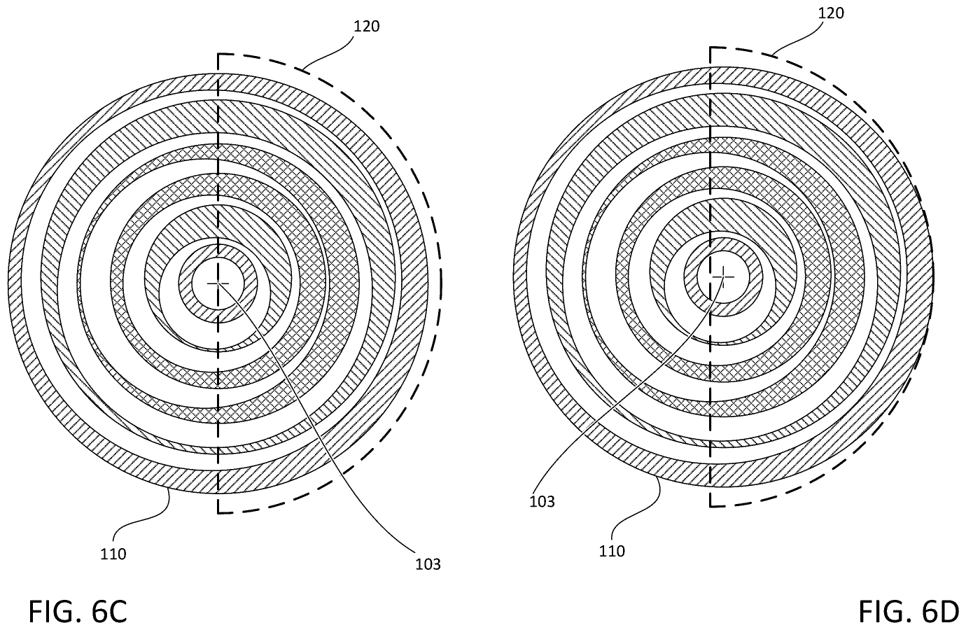

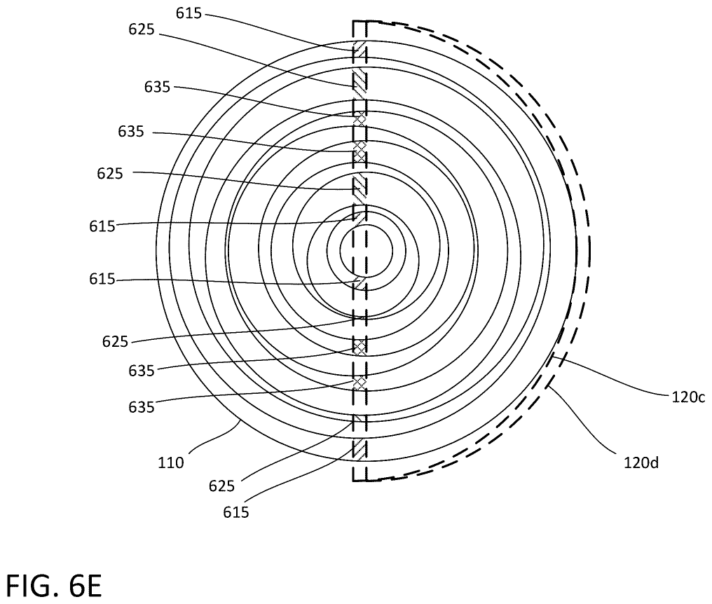

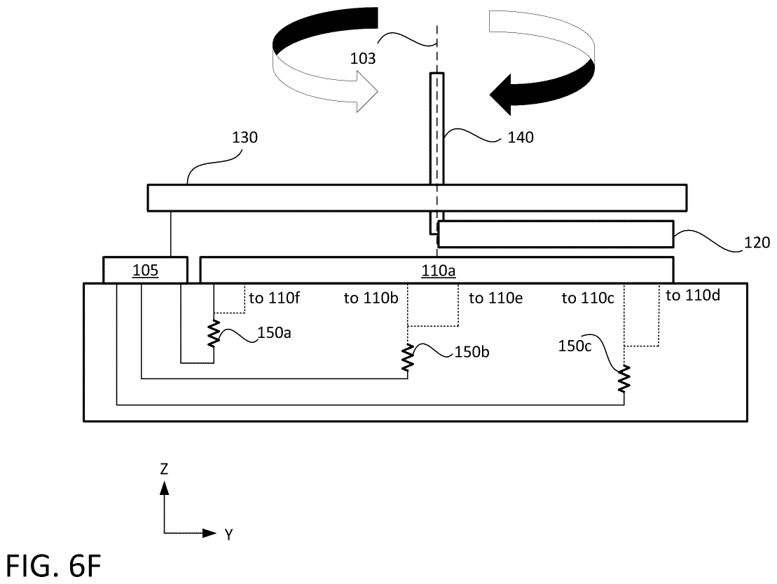

In some applications of a device 100 of the present disclosure, the rotor 120 is precisely aligned at the center 103 in order to achieve an axis of rotation that produces accurate enough measurements to effectively detect the changes in capacitance and thereby the resultant position of the rotor 120. FIGS. 6A-6F illustrate an example device 100 of the present disclosure which does not require such an accurate alignment of the rotor 120 at the center 103, which may allow for the use of lower cost mechanical components, as a reduced level of accuracy is required.

As shown in FIG. 6A, each pad of the plurality of pads 110 is a (outwardly) circular, 360-degree capacitive sensor separated from adjacent pads 110 via a non-conductive separator 640a-d (generally or collectively, separator 640). As shown in FIG. 6B, the pads 110 are coaxially aligned on the same center 103, while the separators 640, while circular, are not aligned on a shared center with one another (although an innermost separator 640f or additional separators may be so aligned). In various embodiments, the separators 640 may be overlaid onto the pads 110, the pads 110 may be exposed from under a material defining the separators 640, or may be coplanar with the separators 640, where outer radii 650a-g of the pads 110 are defined coaxially to a shared center 103, while inner radii 660a-f thereof are defined independently of the shared center 103 (but may coincidentally share a center). Although illustrate with the outer radii 650 defined concentrically (e.g., on-center), and the inner radii 660 defined off-center, the present disclosure contemplates that any construction radius 650/660 may be defined on-center or off-center for a given pad 110, and that one or both construction radii 650/660 for a given pad 110 may be both on-center or both off-center.

The plurality of pads 110 may include reference pads 610a-b (generally or collectively, reference pads 610), sine pads 620a-b (generally or collectively, sine pads 620), and cosine pads 630a-b (generally or collectively, cosine pads 630), which are pad sensors configured to measure capacitance. The rotor 120 may be a half circle shape and positioned on-center to or off-center from the center 103 by various amounts, which the design shown in FIGS. 6A-6E compensates for. As described with respect to FIGS. 2A-2C, rotation of the rotor 120 relative to the pads 110 produces various waveforms of capacitance values via changes in capacitance and the noted time differences in those changes in capacitance affecting the phase of the waveforms. As discussed herein, rotation of the rotor 120 produces a first sinusoidal wave (e.g., a sine wave) via the sine pads 620, a cosine wave via the cosine pads 630 (e.g., a cosine wave or a sine wave 90 degrees out of phase relative to the waveform generated by the sine pad 620), and a sinusoidal reference wave via the reference pads 610. Accordingly, the measured capacitance from the reference pads 610, CapRef, the measured capacitance from the sine pads 620, CapSin, and the measured capacitance from the cosine pads 630, CapCos, may be used to determine the angle of the rotor 120 according to Formula 6:

$$Angel = arc tan \frac{( CapCos - CapRef )}{( CapSin - CapRef )} \qquad Formula 6$$

In various embodiments, reference pads 610 are positioned such that the first reference pad 610a is an outermost pad 110 and the second reference pad 610b is an innermost pad 110. Following this arraignment, the first sine pad 620a may be the next innermost pad, followed by the first cosine pad 630a, the second cosine pad 630b, and the second sine pad 620b moving outward from the center 103. It should be appreciated that the positions of these pads 110 may be adjusted in alternative embodiments. For example, the sine pads 620 may be the outermost and innermost pad 110, respectively, followed by either the reference pads 610 or the cosine pads 630. In another embodiment, the cosine pads 630 are the outermost and innermost pads 110, respectively, followed by either the reference pads 610 or the sine pads 620.

In each arrangement of the plurality of pads 110 with respect to FIG. 6A, the two pads of the same type, for example the sine pads 620, are connected to the circuitry 105 such that the two pads 110 electrically form a single sensor. Because the innermost pad of the pair (e.g., the second sine pad 620b) react more to any axis offset error than the outermost pad 110 of the pair (e.g., the first sine pad 620a), and experiences more variances in capacitance measurements, the shape of more outer pad 110 of the pair may compensate for the axis offset. In order to achieve this effect, each pad 110 has at least one inner construction radius 650/660 that is further modulated to be off center relative to the center 103 to produce the shape of each pad 110.

In various embodiments, the difference value of the outside construction radius 650 of a given pad 110 (i.e., the construction radius of the outermost edge of the circular band-shaped sensor pad) minus the inner construction radius 660 of the given pad 110 (i.e., the construction radius of the innermost edge of same the circular band-shaped sensor pad) should be the same for each pad 110 of the plurality. For example, the difference between the first outer radius 650a and the first outer radius 660a (e.g., for the first pad 110a) should be equal to the difference of between the outer radius 650 and the inner radius 660 of any other pad 110.

After the inner construction radius 660 and outer construction radius 650 are determined, the values of the radii are squared, and then the selected modulation of each pad 110 is applied. For example, a cosine modulation may be applied for each given angle at the required resolution to obtain polar coordinate magnitude values. The square root of each value is then determined, which results in the area of each pair of pads 110 that form a single sensor. For example, the combined area of the sine pads 620 is equal to the combined area of cosine pads 630 and is equal to the combined area of reference pads 610. Because the construction radii 650/660 are squared before modulation, and the square root is applied after, the outside construction radius 650 of each pad 110 minus the inner construction radius 660 for that pad 110 is equal for all pads 110, which provides axis error correction in detecting the change in capacitance.

As shown in FIGS. 6C-6E, the rotor 120 may be on center (as in FIG. 6C) or offset from the center 103 (as in FIG. 6D). FIG. 6E illustrates offset areas for the pads 110 between the example on-center rotor 120c (from FIG. 6C) and off-center rotor 120d (from FIG. 6D) such that the total area of reference offset 615 for the reference pads 610, the total area of sine offset 625 to the sine pads 620, and the total area of cosine offset 635 for the cosine pads 630 are equal to one another, as the formula used to determine the angle of the rotor 120 subtracts the measured capacitance of the reference pads 610 from both of the other sensors (e.g., the sine and cosine pads 620-630), the axis offset is almost entirely cancelled for reasonable offsets.

Although illustrated in FIG. 6F as a partially exploded view (e.g., with a gap between the rotor 120 and the pads 110 and a gap between the rotor 120 and the ground plane 130 for case of visualizing the components), the present disclosure contemplates that the rotor 120 may be in physical contact with the pads 110 and the ground plane 130 so that capacitive communication is increased/established between the pads 110 and the ground plane 130, with portions of the rotor 120 via the present of the portions of the rotor 120 between corresponding pads 110 and the ground plane 130.

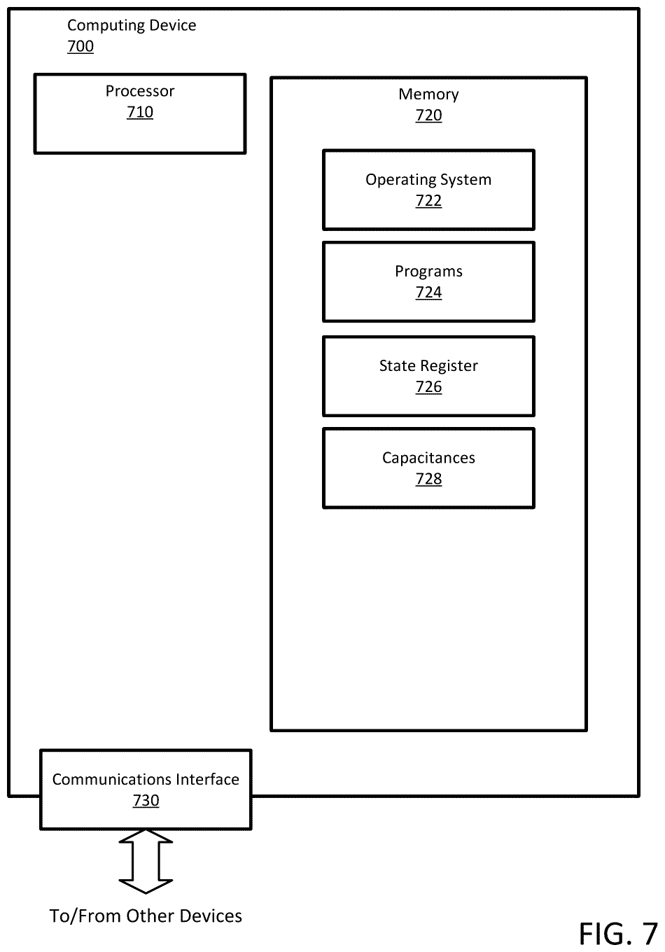

FIG. 7 illustrates a computing device 700, as may be used as or in communication with the circuitry 105 to measure capacitance with the described device 100, according to embodiments of the present disclosure. The computing device 700 may include at least one processor 710, a memory 720, and a communication interface 730.

The processor 710 may be any processing unit capable of performing the operations and procedures described in the present disclosure. In various embodiments, the processor 710 can represent a single processor, multiple processors, a processor with multiple cores, and combinations thereof.

The memory 720 is an apparatus that may be either volatile or non-volatile memory and may include RAM, flash, cache, disk drives, and other computer readable memory storage devices. Although shown as a single entity, the memory 720 may be divided into different memory storage elements such as RAM and one or more hard disk drives. As used herein, the memory 720 is an example of a device that includes computer-readable storage media, and is not to be interpreted as transmission media or signals per se.

As shown, the memory 720 includes various instructions that are executable by the processor 710 to provide an operating system 722 to manage various features of the computing device 700 and one or more programs 724 to provide various functionalities to users of the computing device 700, which include one or more of the features and functionalities described in the present disclosure. One of ordinary skill in the relevant art will recognize that different approaches can be taken in selecting or designing a program 724 to perform the operations described herein, including choice of programming language, the operating system 722 used by the computing device 700, and the architecture of the processor 710 and memory 720. Accordingly, the person of ordinary skill in the relevant art will be able to select or design an appropriate program 724 based on the details provided in the present disclosure. The memory 720 may include a state register 726 to identify a direction of travel of a rotor 120 based on the observed capacitances, and may store capacitance values 728 for calculating an average capacitance seen over a given time or for use in a calculations against other observed or derived capacitance values.

The communication interface 730 facilitates communications between the computing device 700 and other devices, which may also be computing devices as described in relation to FIG. 7. In various embodiments, the communication interface 730 includes antennas for wireless communications and various wired communication ports. The computing device 700 may also include or be in communication, via the communication interface 730, one or more input devices (e.g., a keyboard, mouse, pen, touch input device, etc.) and one or more output devices (e.g., a display, speakers, a printer, etc.).

Although not explicitly shown in FIG. 7, it should be recognized that the computing device 700 may be connected to one or more public and/or private networks via appropriate network connections via the communication interface 730. It will also be recognized that software instructions may also be loaded into a non-transitory computer readable medium, such as the memory 720, from an appropriate storage medium or via wired or wireless means.

Accordingly, the computing device 700 is an example of a system that includes a processor 710 and a memory 720 that includes instructions that (when executed by the processor 710) perform various embodiments of the present disclosure. Similarly, the memory 720 is an apparatus that includes instructions that, when executed by a processor 710, perform various embodiments of the present disclosure.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

As used herein, various chemical compounds are referred to by associated element abbreviations set by the International Union of Pure and Applied Chemistry (IUPAC), which one of ordinary skill in the relevant art will be familiar with. Similarly, various units of measure may be used herein, which are referred to by associated short forms as set by the International System of Units (SI), which one of ordinary skill in the relevant art will be familiar with.

As used herein, “about,” “approximately” and “substantially” are understood to refer to numbers in a range of the referenced number, for example the range of −10% to +10% of the referenced number, preferably −5% to +5% of the referenced number, more preferably-1% to +1% of the referenced number, most preferably-0.1% to +0.1% of the referenced number.

Furthermore, all numerical ranges herein should be understood to include all integers, whole numbers, or fractions, within the range. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth.

As used in the present disclosure, a phrase referring to “at least one of” a list of items refers to any set of those items, including sets with a single member, and every potential combination thereof. For example, when referencing “at least one of A, B, or C” or “at least one of A, B, and C”, the phrase is intended to cover the sets of: A, B, C, A-B, B-C, and A-B-C, where the sets may include one or multiple instances of a given member (e.g., A-A, A-A-A, A-A-B, A-A-B-B-C-C-C, etc.) and any ordering thereof. For avoidance of doubt, the phrase “at least one of A, B, and C” shall not be interpreted to mean “at least one of A, at least one of B, and at least one of C”.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

We claim:

1. A capacitive sensing device, comprising:
a plurality of pads disposed around a center of a base disposed in a first plane;
a ground plane, positioned in a second plane above the base;
a rotor, disposed in a third plane between the first plane and the second plane and configured to rotate about the center;
a sensing circuit, electrically connected to each pad of the plurality of pads and the ground plane, and configured to determine a rotational position of the rotor relative to the base based on a change in capacitance when the rotor is positioned between a given pad of the plurality of pads and the ground plane versus when the rotor is not positioned between the given pad and the ground plane; and
wherein the given pad of the plurality of pads is divided into a first pad section and a second pad section that is coaxially separated from the first pad to both occupy a given arc at different distances from a reference point of the center.

2. The device of claim 1, wherein the first pad section has a first inner radius and the second pad section has a second outer radius, wherein a second pad of the plurality of pads occupies a second arc outside of the first arc at a distance between the first inner radius and the second outer radius.

3. The device of claim 2, wherein a combined area of the first pad section and the second pad section is substantially equal to an area of the second pad.

4. The device of claim 2, wherein first straight edges of each of the first pad section, the second pad section, and the second pad are co-linear to one another along a first alignment axis.

5. The device of claim 3, wherein second straight edges of each of the first pad section, the second pad section, and the second pad are co-linear to one another along a second alignment axis perpendicular to the first alignment axis.

6. The device of claim 1, wherein the rotor is shaped to be one of a:
a semi-circle;
a limaçon;
a gear-shape, defining a plurality of paddles extending from a central body for a predefined distance at a regular interval about the central body.

7. The device of claim 1, wherein the sensing circuit is configured to determine the rotational position of the rotor via detecting a differential capacitance between pads of the plurality of pads that are positioned on opposite sides of the center.

8. The device of claim 1, wherein the rotor is composed of a material have a relative permittivity at least four times greater than the relative permittivity of free space.

9. The device of claim 1, wherein the rotor is shaped and sized such that, at any given time, the rotor is positioned completely over exactly one pad of the plurality of pads and is positioned such that rotor is not at all positioned over exactly one pad of the plurality of pads.

10. A capacitive sensing device, comprising:
a plurality of six pads disposed around a center of a base disposed in a first plane;
a ground plane, positioned in a second plane above the base;
a rotor, disposed in a third plane between the first plane and the second plane and configured to rotate about the center;
a sensing circuit, electrically connected to each pad of the plurality of pads and the ground plane, and configured to determine a rotational position of the rotor relative to the base based on a change in capacitance when the rotor is positioned between a given pad of the plurality of pads and the ground plane versus when the rotor is not positioned between the given pad and the ground plane; and
wherein the plurality of six pads are disposed concentrically to one another, each defining a 360 degree arc around the center.

11. The device of claim 10, wherein a first pair of the six pads are connected to the sensing circuit via a first trace as a first capacitance sensor, a second pair of the six pads are connect to the sensing circuit as a second capacitance sensor, and a third pair of the six pads are connected to the sensing circuit as a third capacitance sensor, wherein the third sensor is disposed between the second pair of the six pads and the second sensor is disposed between the first pair of the six pads.

12. The device of claim 11, wherein:
the first sensor is a first one of:
a reference sensor;
a sine sensor; and
a cosine sensor;
the second sensor is a second one of:
the reference sensor;
the sine sensor; and
the cosine sensor; and
the third sensor is a third one of:
the reference sensor;
the sine sensor; and
the cosine sensor.

13. The device of claim 12, wherein the rotor is positioned off-center relative to the center, wherein a reference capacitance measured from the reference sensor is subtracted from a sine capacitance measured from the sine sensor and subtracted from a cosine capacitance measured from the cosine sensor to calculate an angle of rotation of the rotor that compensates for the rotor being positioned off-center relative to the center.

14. The device of claim 10, wherein for each given pad of the plurality of six pads, a given difference between a given outer radius of a given pad and an inner radius of the given pad is substantially equal to a second difference between a second outer radius and a second inner radius for every other pad of the plurality of six pads.

15. The device of claim 10, wherein the rotor is shaped to be one of a:
a semi-circle;
a limaçon;
a gear-shape, defining a plurality of paddles extending from a central body for a predefined distance at a regular interval about the central body.

16. A capacitive sensing device, comprising:
a plurality of pads disposed on a base around a center of the base;
a ground plane positioned above the plurality of pads;
a rotor, positioned between the ground plane and the plurality of pads, configured to at least partially rotate about the center resulting in a portion of the rotor being positioned over different portions of the plurality of pads at different angles of rotation; and
sensing circuitry connected to the plurality of pads in order to determine a position of the rotor; and
wherein at least two pads of the plurality of pads are disposed in a shared arc defined from the center.

17. The device of claim 16, wherein each pad of the plurality of pads is disposed concentrically to one another, wherein the shared arc defines a 360 degree arc around the center.

18. The device of claim 17, wherein for each given pad of the plurality of pads, a given difference between a given outer radius of a given pad and an inner radius of the given pad is substantially equal to a second difference between a second outer radius and a second inner radius for every other pad of the plurality of six pads.

19. The device of claim 16, wherein the at least two pads of the plurality of pads that are disposed in the shared arc act as a single pad that is divided into a first pad section and a second pad section that is coaxially separated from the first pad to both occupy the shared arc at different distances from a reference point of the center.

20. The device of claim 19, where the first pad section and the second pad section define a combined surface area that is substantially equal to an individual surface area of every other pad of the plurality of pads.
